(19) United States
(12) Patent Application Publication
(10) Pub. No.: US 2007/0102339 A1
(43) Pub. Date: May 10, 2007

(54) Membrane filtration apparatus and process optionally for sand filter retrofit

(76) Inventors: Pierre Lucien Cote, Dundas (CA); Nicholas William H. Adams, Hamilton (CA)

Correspondence Address: THE FARRELL LAW FIRM, 333 EARLE OVINGTON BOULEVARD., SUITE 701, UNIONDALE, NY, 11553, US

(21) Appl. No.: 11/593,001

(22) Filed: Nov. 6, 2006

Related U.S. Application Data
(60) Provisional application No. 60/740,641, filed on Nov. 30, 2005.

(30) Foreign Application Priority Data
Nov. 8, 2005 (CA) 2,525,985

(51) Int. Cl. B01D 63/00

(52) U.S. Cl. 210/321.69; 210/321.89; 210/321.8

(57) ABSTRACT

A filtration apparatus has a horizontally oriented permeate conduit supported on the floor of a tank. A module of filtering membranes may be placed on or over the permeate conduit and communicate with the permeate conduit. The module may be of a variety of configurations including one with vertically oriented hollow fibers. A permeate collector may be connected to the permeate conduit by a second permeate conduit. The connection may be made near the top of the module and may be through an isolation valve. The apparatus is suitable, among other things, for installation in a sand filter tank. Permeation may be by gravity flow. This abstract is not to be used to construe the claims.

This is an application claiming the benefit under 35 USC 119(e) of U.S. Application Ser. No. 60/740,641 filed Nov. 30, 2005 and claims priority to Canadian Application Serial No. 2,525,985 filed Nov. 8, 2005. U.S. Application Ser. No. 60/740,641 and Canadian Application Serial No. 2,525,985 are incorporated herein, in their entirety, by this reference to them.

### FIELD

This document relates to membrane filtration devices or processes.

### BACKGROUND

The following background description does not admit that anything discussed below is citable as prior art or is part of the general knowledge of a person skilled in the art.

A sand filter, or rapid sand filter may have a tank about 3 m deep. A set of parallel underdrain pipes may lay horizontally near the bottom of the tank and be connected, for example through a header, to an outlet pipe near the bottom of the tank. The outlet pipe may be connected to a T-fitting such that filtrate can be removed from the tank through the underdrain pipes or wash water can flow into the underdrain pipes. A layer of gravel, for example about 45 cm thick, covers the underdrain pipes. A layer of sand or sand and anthracite covers the gravel, for example in a layer about 75 cm thick. Generally horizontal wash water troughs span across the tank between the top of the sand or anthracite and the top of the tank and connect to a backwash outlet. A raw water inlet allows feed into the tank from near the top of the tank. During filtration, water is fed into the tank to maintain a water level near the top of the tank to provide a head relative to the outlet to drive water through the anthracite, if any, sand, gravel and underdrain pipes to the outlet. During a backwash, the water surface is lowered to just over the edges of the wash water troughs and wash water is fed into the outlet to provide an upward flow through the gravel, sand and anthracite, if any. A gas may also be supplied from below. This upward flow carries filtered solids to the wash water troughs and out the backwash outlet.

In U.S. Pat. No. 6,893,568 issued May 17, 2005 to Janson et al., modules of ultrafiltration or microfiltration membranes are arranged in a tank open to the atmosphere to substantially cover the cross sectional area of the tank. A filtration cycle has permeation steps and deconcentration steps. During permeation, supply of feed substantially equals feed removed and little if any aeration is used. During deconcentration, aeration with scouring bubbles is provided with one or both of backwashing and feed flushing. In feed flushing, feed water is supplied to the tank from below the modules. Excess tank water created during deconcentration flows generally upwards through the modules and out through a retentate outlet or overflow at the top of the tank.

Introduction

This document describes, among other things, one or more membrane filtration apparatuses, processes or systems; methods of converting a sand filter into a membrane filtration system and operating such a system; and, a kit of items to integrate immersed membranes into an existing sand filter. One or more inventions may be disclosed but the following introduction is intended to introduce the reader to the contents of this document rather than to define any particular invention. One or more inventions may reside in combinations or sub-combinations of one or more apparatus elements or process steps described in this or other parts of this documents, for example the detailed description or claims.

This document describes a membrane filtration apparatus, a system and a process that may be used, for example, in a newly built plant or to retrofit, or provide a method or kit or parts to retrofit, a sand filter or operate the retrofit system. The module may have a plurality of membranes held in a mass of potting material with ends open to a permeate collector. The membranes may be hollow fiber membranes oriented vertically and the permeate collector may communicate with upper ends of the membranes. A permeate pipe may carry collected permeate from one or more modules upwards or down towards the bottom of the module. A releasable connection between the permeate pipe and the permeate collector may be made near or above an upper potting head or the top of the module. An isolation valve may be placed in the permeate pipe or between the permeate collector and the permeate pipe. The releasable connector or isolation valve or both may be configured such that the module can be removed from the permeate pipe by moving the module or permeate pipe vertically. Further optionally, the bottom of the module may have a gas distributor which may comprise holes through a mass of potting material holding lower ends of the membranes and a skirt or chamber. A system may have permeate or gas pipes or both placed horizontally across or near the bottom of a tank, optionally supported by the bottom of the tank. The pipes may optionally be made in segments attached end to end. The pipes may rest on or be integral with a pedestal. One or more modules may rest on the pedestal, optionally without being connected to the pedestal. The pedestal may comprise a tray which may assist in locating a bottom part of the module and may have openings to allow air to flow from gas pipes to the modules. Optionally, wash water troughs may be located in the tank above the modules to remove retentate from the tank. If the modules or system are optionally being used to retrofit a sand filter tank, one or more of the permeate pipe, gas pipes or troughs may be connected to preexisting filtrate, gas supply and backwash water removal systems of the sand filter respectively. The system may optionally be operated with transmembrane pressure for permeation provided by head difference or between the feed in the tank and a permeate outlet, suction or siphon. Deconcentration or retentate removal may optionally be by overflow to the troughs. A kit to integrate immersed membranes into a sand filter may comprise one or more of the parts mentioned above.

This document also describes a filtration apparatus comprising a lower potting head having a plurality of air passages, an upper potting head, a plurality of hollow fiber membranes extending between the potting headers, the membranes each having a membrane wall and a lumen, the membrane walls sealed to the potting heads, the lumen in communication with an upper surface of the upper potting head, a permeate collector sealed to the upper header and defining a permeate collection zone over the upper potting head and in communication with the lumens of the membranes, a first permeate conduit in communication with and extending generally vertically downwards from the permeate collection zone and, a releasable connection between the permeate collector and the first permeate conduit located near or above the upper potting head.

This document also describes a filtration apparatus comprising, a pedestal further comprising a lower surface adapted to rest on a tank floor and an upper surface adapted to support a membrane assembly; a second permeate pipe held by the pedestal; and, a first permeate pipe extending upwards from the second permeate pipe.

This document also describes a permeate isolation valve having a cylindrical body, with ports through the body, a first end adapted to be connected to a permeate pipe and a plunger with a seal inside of the body and movable between a first position in which the seal is between the ports and the first end and a second position in which the seal is on the other side of the ports from the first end. A membrane module may have a permeate collector adapted to seal to the outside of the valve body. The permeate collector may be slidable over the valve body.

This document also describes a membrane module having a first potting head, a plurality of gas passages through the potting head, a bundle of hollow fiber membranes having first ends potted in and dispersed about the first potting head, a second potting head, a spacer between the potting heads, and second ends of the membranes potted into the second potting head in two or more sub bundles.

This document also describes a kit to integrate an immersed membrane into existing sand filters while minimizing changes to the existing plant. The kit is installed in-situ, optionally from all-plastic components that can be transported by a person, without the use of machinery. Permeate and air headers are built in-situ at the bottom of the sand filter tank. Modules are installed and removed from the top without having to disassemble any piping. Air (from degassing or after a membrane integrity test) is removed via the bottom through a fine tube inserted into the header. Modules can be installed without removing existing backwash channels. The retrofitted plant can be used with the existing feed inlet and filtrate outlets. The membrane modules may produce a similar filtration rate to the existing sand filter to reduce the extent of any changes required to the remainder of the plant. Optionally, fine tubes from the permeate cavity of each module may be connected individually to a pneumatic control system. The pneumatic control system may be used to assist in providing one or more ancillary functions. For example, the pneumatic control system may be used for one or more of extracting air from the permeate side of the modules, performing a membrane integrity test or isolating a module or group of module from the rest of the system.

This document also describes a module pedestal with interconnected permeate and air headers.

This document also describes a permeate connection at the bottom of a module.

This document also describes a cassette-less construction for a plurality of filtering modules.

This document also describes a walking deck part of a module.

This document also describes a system and process for air removal within a header of a module using a vacuum tube line.

This document also describes an air removal conduit independent of a permeate header and situated below an air inlet level and an associated method of operation.

This document also describes a pressure actuated isolation valve built into a module permeate header or between a module permeate header and a permeate conduit.

This document also describes a pneumatic control system operable to do one or more of extract air, perform a membrane integrity test (MM or isolate a module or group of modules.

This document also describes a process for providing a continuous rotating MIT without production interruption.

This document also describes a system and process for air removal from degassing or after an MIT.

This document also describes an automatic isolation of modules not meeting an integrity criterion.

### BRIEF DESCRIPTION OF THE DRAWINGS

FIG. 1 is an isometric view of a module pedestal for a horizontal fiber module.

FIG. 2 is an isometric view of a module pedestal for a vertical fiber module.

FIG. 3a is a plan view of a filtration tank partially covered with module pedestals.

FIG. 3b is an elevation section of a filtration tank with modules of vertical hollow fibers.

FIG. 4 is an elevational section view of a module of horizontal hollow fibers on the pedestal of FIG. 1.

FIG. 5 is an elevational section view of a module of vertical hollow fibers on the pedestal of FIG. 2.

FIG. 6 is a schematic representation of part of an optional air extraction system.

FIG. 7 is an isometric view of another pedestal with an array of eight of another module on the pedestal.

FIG. 8 is a top, side and bottom view of a module of the array of FIG. 7.

FIG. 9 is a cross section of the array of FIG. 7 cut through the modules.

FIG. 10 is a cross section of the array of FIG. 7 cut through a permeate pipe between modules.

FIG. 11 is an exploded view of a module of FIG. 7.

FIG. 12 is an isometric view of the pedestal of FIG. 7.

FIG. 13 is a section of a valve from FIG. 7 in a closed position.

FIGS. 14 shows plan views of alternate upper header surrounds of the module of FIG. 7.

FIG. 15a is an elevational view of a second module pedestal for a horizontal fiber module.

FIG. 15b is an elevational view of a second module pedestal for a vertical fiber module.

FIG. 16 is an elevational section view of a second module of horizontal fibers on the second pedestal of FIG. 15a.

FIG. 17 is a schematic representation of a pneumatic valve.

FIG. 18 is a schematic representation of a pneumatic control system.

### DETAILED DESCRIPTION

Various apparatuses or processes will be described below including an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. All rights are reserved in any invention disclosed in an apparatus or process that is not claimed in this document. Any one or more features of any one or more embodiments can be combined with any one or more features of any one or more other embodiments.

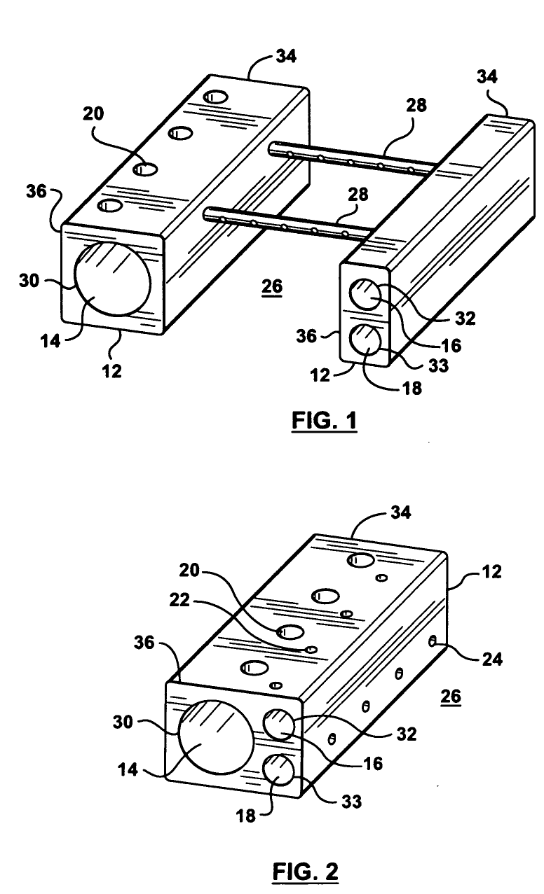

Referring to FIGS. 1-6, the bottom 8 of a filtration tank 10, which may have been formerly used as a sand filter, is prepared to install an immersed membrane retrofit kit by removing the existing underdrain system, for example pipes, and optionally pouring a level layer of concrete into which tracks (not shown) are optionally inserted to secure the module pedestals 12.

The retrofit kit includes a module pedestal 12 which may be adapted for use with a variety of modules. Each pedestal 12 may be a block or assembly, made for example of plastic, that can be fixed or rest at the bottom 8 of the tank 10 and may contain or form, alone or in combination with other pedestals 12, one or more of: a section of permeate conduit 14; a section of gas or aeration conduit 16; a section of air removal conduit 18; connectors for permeate 20, scouring air 22 and permeate air removal 24; and, a feed-and-drain channel 26 and aeration pipes 28. The pedestal 12 may be made, for example, by a process comprising injection molding or extrusion optionally with further operations such as drilling, milling, gluing or welding to create various passageways or assemblies.

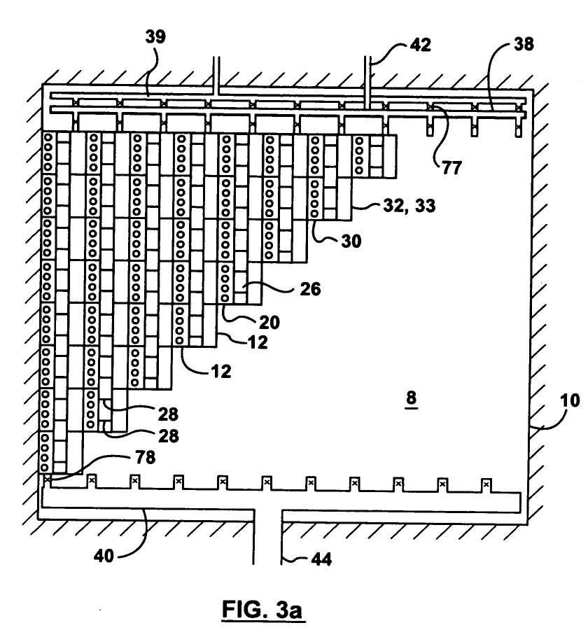

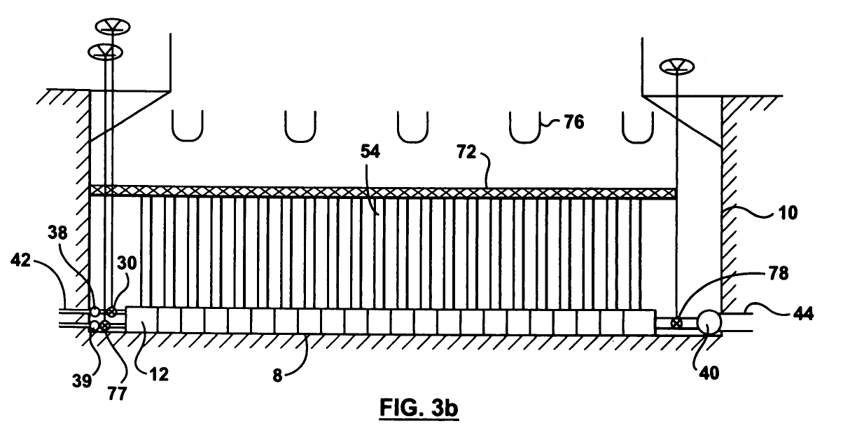

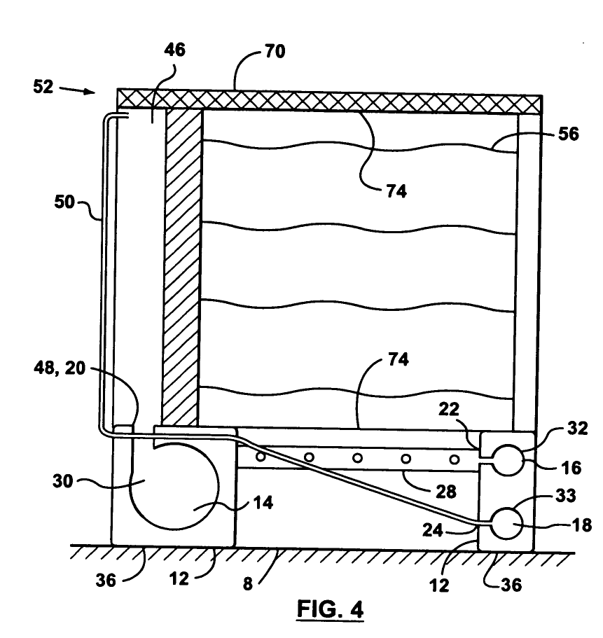

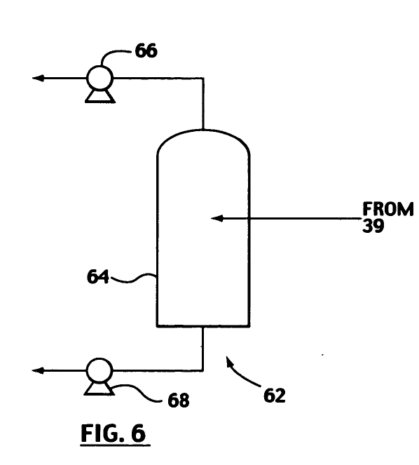

Pedestals 12 are laid at the bottom 28 of the tank 10 and connected longitudinally to form permeate 30 and aeration headers 32 and air removal headers 33 as shown in FIGS. 3a and 3b. Each pedestal 12 has interconnecting male 34 and female 36 ends that may be sealed together by, for example, o-rings, gluing or welding. The bottom 8 of the tank 10 may be completely or generally covered by module pedestals 12 optionally except for the end(s) where room may be left for connecting permeate 30 and air 32 headers into manifolds 38, 40 that tie to the existing sand filter piping network 42, 44. For sand filters without a gas backwash system, gas pipe network 42 a blower and related ancillary equipment and controls may be added. Optionally, air removal headers 33 may connect to air removal manifold 39 which connect to an air extraction system 62 shown in FIG. 6. Feed may enter the tank 10 from an inlet near the top of the tank 10.

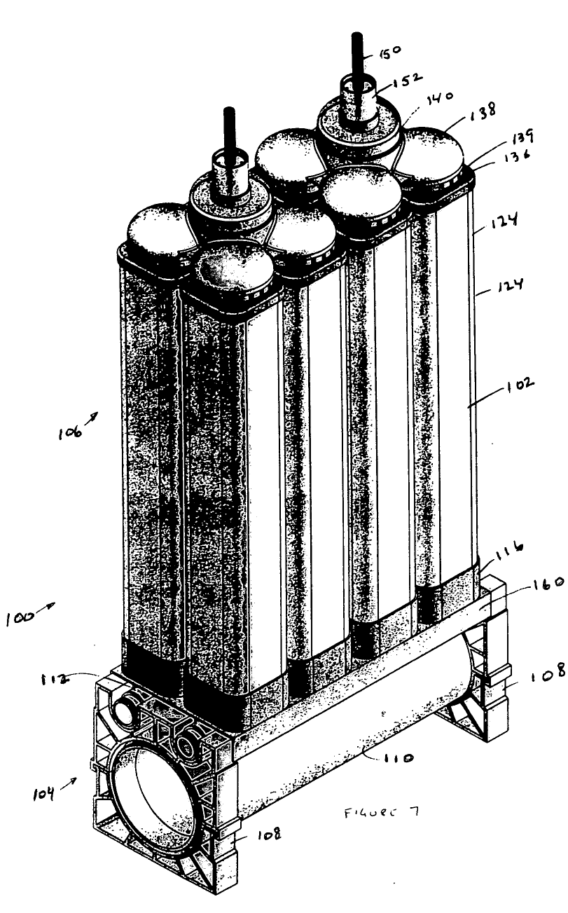

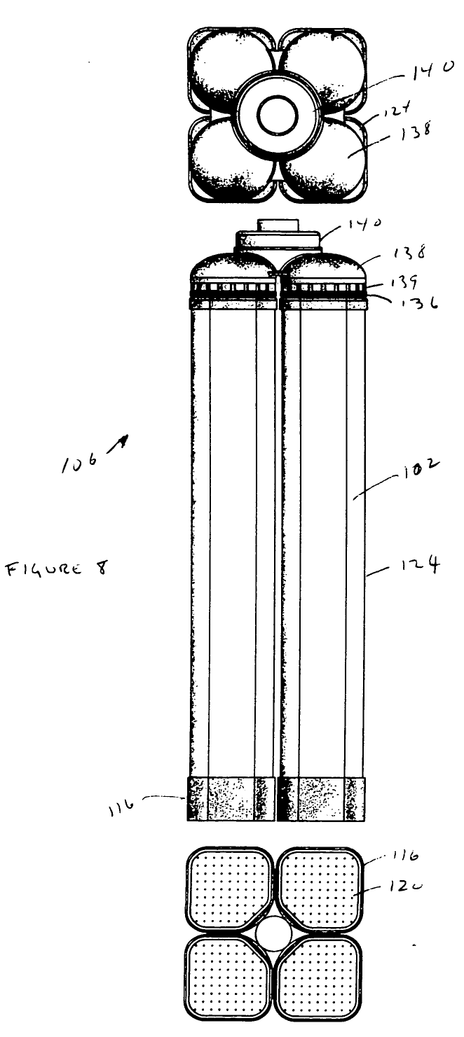

A horizontal module 52 may resemble a standard ZW-1000 module made by Zenon Environmental Inc. Such a module is described in U.S. Pat. No. 6,325,928 issued Dec. 4, 2001, which is incorporated in its entirety herein by this reference to it. The horizontal module 52 may have a permeate header 46 as shown in FIG. 4 with a permeate port 48 at the bottom of the header 46, instead of at the back as in a ZW-1000 module, to connect to the permeate conduit 14 in the pedestal 12. Alternately module 52 may have a permeate header with a permeate port at the top. In this case, groups of modules 52, for example 2 to 6, may be fitted with a permeate manifold near the top of the modules and connected to a vertical permeate pipe in a manner analogous to FIGS. 7 to 14. A fine tube 50, for example less than 10 mm inside diameter or between 3-5 mm, may be inserted into the top portion of the header 46 and connected to an optional air removal conduit 18. Hollow fiber membranes may be between 0.1% and 5%, for example about 2%, longer than the distance between the header 46 and an opposed potting head.

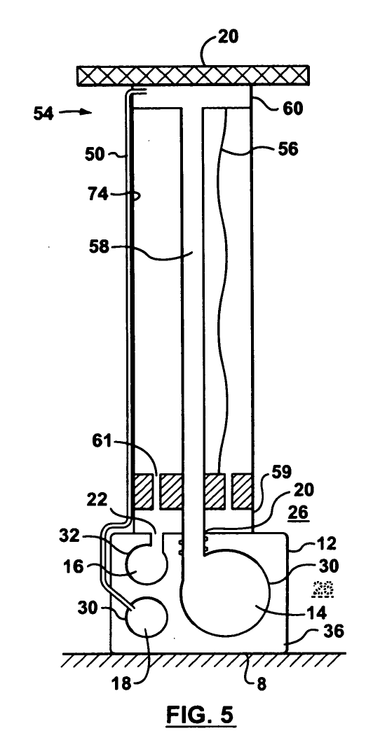

FIG. 5 shows a section view of a vertical module 54 with vertical fibres 56 on a pedestal 12. The module shown is cylindrical, with radially and circumferentially distributed air holes through the potting material of the lower header, optionally called a potting head, although rectangular or other shaped headers may also be used. The vertical module 54 has an interior, optionally central, permeate tube 58 to bring the filtered water to the bottom permeate conduit 14 in the pedestal 12. The vertical module 54 also has an air distribution chamber 59 or skirt which may be used to release air through air passages 61.

FIGS. 4 and 5 show an optional continuous flexible air removal tube 50 connecting the top of the module permeate cavity 60 to the air removal conduit. Further optionally, two sections of this tube 50 may be integrated into the header 46 and the pedestal 12, respectively, and connected together via a quick-connect mechanism (not shown) when the module 52, 54 is inserted into position.

For both module 52, 54 configurations, air may be removed from the permeate header 46, for example air from degassing or after a membrane integrity test, through the fine air removal tube 50, the air removal conduit 18 and an air extraction system 62 as shown in FIG. 6. The air extraction system 62 may be common to all membrane rows in the tank 10 although individual rows may be isolated by air removal isolation valves 77, for example when a row is taken out of service. The air extraction system may run throughout permeation, but only has to handle a very small fraction of the permeate flow because head loss through the fine tubes 50 causes very low flow rates even though the pressure in the air extraction system is lower (i.e., the air extraction system 62 has a stronger vacuum) than the permeate withdrawn system. The air extraction system 62 receives air or permeate or both through the air removal manifold 39. Vacuum pump 66 is operated to draw air from the air removal manifold 39. When all air has been drawn out, an amount of permeate may also be drawn into air extraction chamber 65. This permeate is removed by liquid pump 68, which may also be a drain. Liquid pump 68 turns on whenever a sensor indicates that extraction chamber 64 has a certain level of liquid in it. In this way, when air is present in the header 46, it is sucked through this network; when not, permeate is extracted. The vacuum applied through this system can by higher than that applied through the permeate extraction network since the amount of permeate flow will be limited by pressure loss through the fine tube 50 section which allows the air extraction system 62 to run during permeation to remove incidental air. On plant or row startup, or after an integrity test, the air extraction system 62 may be run for a period of time before starting permeation to remove air and fully or partially prime the permeate system.

The top of the module 52, 54 may have a plastic cover 70 that forms a walk-on platform 72 when all modules 52, 54 are installed into the tank. Each module 52, 54 may have built-in screens 74, for example plastic mesh with about a 5 mm opening size, at the bottom and at the top for a horizontal fiber module 52 or around the periphery for a vertical fibre module 54.

The membrane system may allow for an increase in filtration rate over a sand filter. Optionally, for a simpler retrofit of existing sand filters, the filtration process may have filtration rates comparable to sand filters. Table 1 shows that only 1 layer of ZW-1000 like modules being for example about 50 to 100 cm high and having 200 to 700 m² of membrane surface area to cubic meter of volume, at a flux of 30 L/m²/h will allow a filtration rate of 15 m/h, higher than most existing sand filters. For vertical modules, for example of 50 cm or more in height, a filtration rate of 15 m/h could be obtained with a larger diameter and shorter fibre than what is currently used in ZW-1000.

TABLE 1
Comparison of filtration rates

Filtration Rate

| Filtration Process | m/h | gpm/ft² |
|---|---|---|
| Conventional sand filter | 5-10 | 2-4 |
| High rate sand filter | 20 | 8 |
| ZW-1000 - 3 module high | 100 | 40 |
| (80% coverage) @ 60 L/m²/h | | |
| ZW-1000 - 1 module high | 15 | 6 |
| (80% coverage) @ 30 L/m²/h | | |

The different functions of a membrane filter are reviewed below.

Filtration may be by gravity using the existing control mechanism at a sand filter plant. Assuming an available head of 2 m (0.2 bar or 20 kPa), a fouled membrane permeability of 150 L/m²/h/bar would allow the membranes to run at a flux of 30 L/m²/h. This is possible with modern microfiltration or ultrafiltration membranes, some of which have a clean water module permeability of about 400 L/m²/h/bar or more.

Membrane backpulse may be done using existing sand filter backwash pumps. Sand filters are typically backwashed once per day, using 4-6% of the water filtered. Membrane filters can use roughly the same total amount of water, but with shorter more frequent backwashes.

An existing blower system, or an added blower for older sand filters that do not have air/water backwash, may be used to air scour the membranes. Isolation valves may be added between the air manifold 38 and the individual aeration headers 32 to allow non-operating rows to be isolated.

Air may be removed from each module using the optional air extraction system 62. Alternately, air may be entrained in the permeate flow and removed in a permeate air collector or allowed to leave the permeate in an open holding tank.

Tank water deconcentration may be by overflow using existing backwash or wash water troughs 76. Total or partial tank drains may also be possible if a connection can be made from the bottom of the tank to the backwash water tank.

For chemical cleaning, if desired, an existing sand filter may be modified by coating surfaces, adding a clean in place network and neutralization equipment. Lowering the membrane packing density (as compared to current ZW-1000 designs), if desired, to approach the filtration rate of existing filters negatively impacts the volume of cleaning solutions. This is offset by reduced fouling rates from operation at lower fluxes. The cleaning procedure may include daily (or less frequent) chlorine maintenance cleaning (acid/base can be used as an alternative) by soaking, using the scouring aeration network or the air removal network for distribution of the cleaning solution, and in-line neutralization on a drain line. Manual recovery cleaning may also be done once or twice per year.

Membrane integrity tests may be done continuously on a rotation basis on module groups such as a full row using connections (not shown) to the permeate headers 30.

A full row of modules may be isolated from the permeate manifold 40 upon failure with a valve 78 at the end of a row that can be accessed from the top of the tank 10 as shown in FIG. 3b. Other isolation valves similarly isolate a row from the other manifolds 38, 39. Optionally, a new filtration system may be built using the pedestals-and modules either in the manner of a retrofit sand filter or with permeation by suction or deconcentration by removing retentate from a drain at the bottom of a tank.

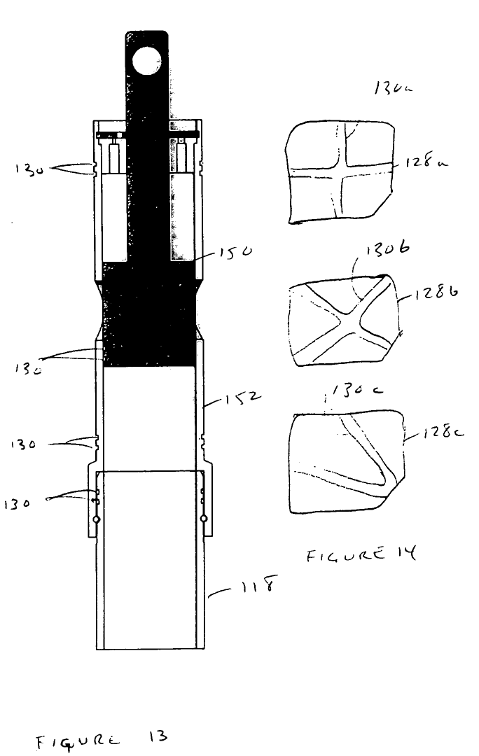

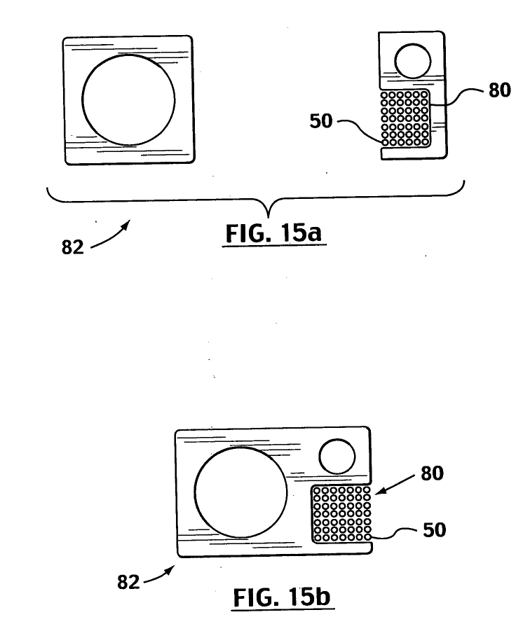

As an option to the design described above, and with reference to FIGS. 15a to 18, the air removal conduit 18 can be replaced by a cavity 80 in a second module pedestal 82 to house air extraction fine tubes 50 from individual second modules 84 or small groups of second modules 84 (2 to 6) in each row (FIGS. 15a and 15b). In this design, the air removal fine tubes 50 shown in FIGS. 4 and 5 extend all the way to a pneumatic control system 86 situated outside of the membrane tank 10.

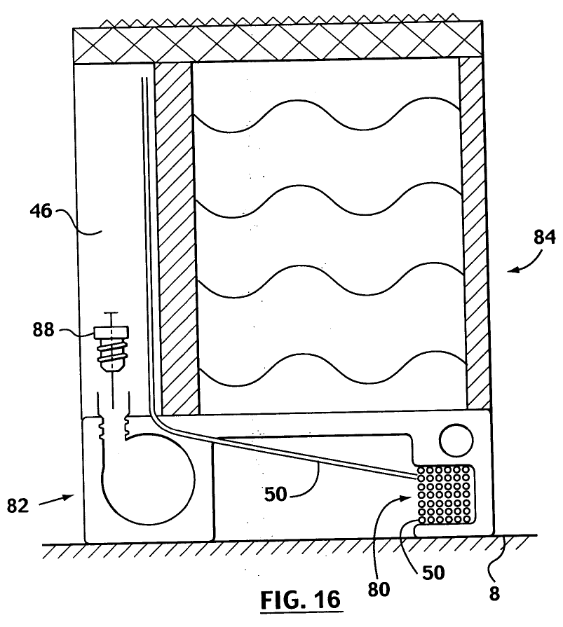

In this optional design, a float valve 88 is integrated into or in communication with the module permeate header 46 to allow module isolation (single module, or small group of modules) in conjunction with the pneumatic control system 86 (shown in FIG. 16 for a horizontal fiber second module 84; not shown for a vertical fiber module). To group second modules 84, the fine tubes 50 from the group of modules are joined together to a single fine tube 50 which extends to the pneumatic control system 86.

The fine tubes 50 in each second module 84 or group of second modules 84 are connected to small 3-way valve manifolds 90 that are used to perform various functions which may include one or more of extracting air from module permeate headers 46, performing a membrane integrity test (MIT), isolating a second module 84 (or group of second modules 84) that fail the MIT. Some of these functions may also be performed with modules 52, 54 not having a float valve 88. Other valves that respond to pressure fluctuations in a fine tube 50 or module permeate header 46 may be used in place of float valves 88.

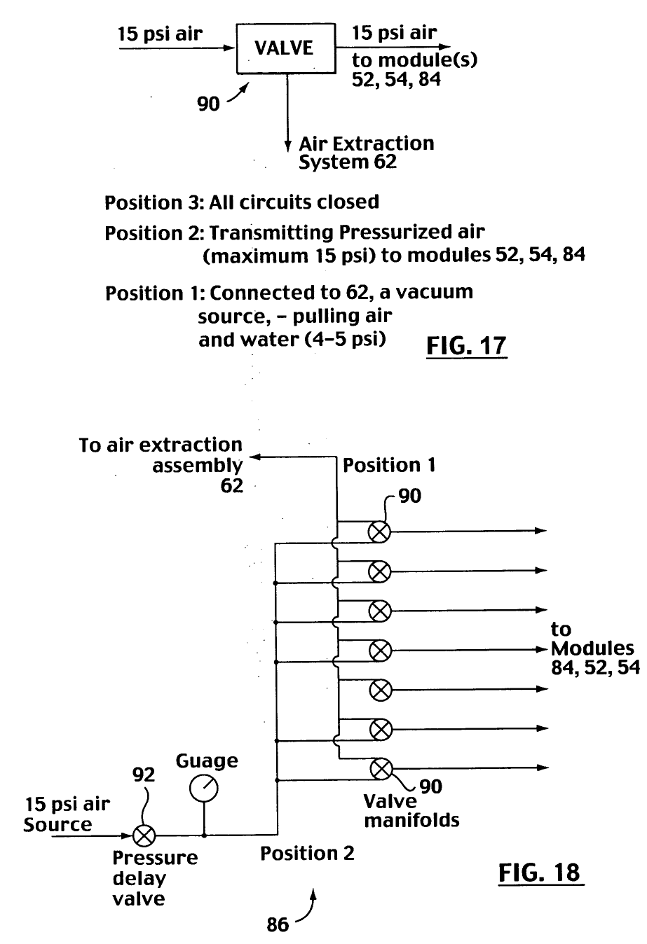

The 3-way valve manifolds 90 (FIG. 17) are pneumatic valve manifolds as often used in control systems but selected or adapted to handle air and water. As shown in FIG. 17, each 3-way valve manifold 90 has the following positions:
Position 1: pulling a vacuum to extract air (water) from permeate side of module(s) 52, 54, 84
Position 2: transmitting pressurized air, for example at 15 psi, to the module(s) 52, 54, 84
Position 3: isolating module(s) 84

During normal operation, the valve manifold 90 is in Position 1 and degassed air is extracted form the module permeate header 46. Air may be removed with a continuous stream of water in 2-phase flow. When the 3-way valve manifold 90 is in Position 1, the header float valve 88, if any, is in an open position and the module 52, 54, 84 is in filtration mode.

To perform a MIT, the pneumatic 3-way valve manifold 90 is switched to Position 2. 15 psi air is transmitted to the module(s) 52, 54, 84 and the water is evacuated through the module permeate header 46 and the membranes 56. The pressurized air also drives the float valve 88 to its closed position and isolates second module(s) 84. For other modules 52, 54, the permeate isolation valve 78 of the relevant row is closed. Once this purge phase is completed, a pressure decay valve 92, which may be common to all modules 52, 54, 84 but connected through a single pneumatic valve manifold 90 to the module(s) 52, 54, 84 being tested, is closed to perform the pressure decay test (PDT) (FIG. 18). During a PDT, all other valve manifolds 90 in communication with the pressure decay valve 92 are either in Position 1 or 3.

After the pressure decay, the pneumatic valve manifold 90 is normally switched back to Position 1 to purge the air and resume filtration. Filtration may resume after the next programmed backwash that will pop the module float 88 open or by opening the permeate isolation valve 78.

If the PDT indicates a failure, the pneumatic valve manifold 90 is toggled between positions 1 and 3 to isolate the second module 84 from permeation (Position 2 to pressurize with 15 psi air and Position 3 when a PDT is done on another module) until it can be repaired. Alternately, an entire row of modules 52, 54 can be isolated by closing a permeate isolation valve 78.

FIGS. 7 to 14 show alternate modules and pedestals that may be used in a new filtration system or process, such as a process with permeation by suction and deconcentration by periodic tank drain or in a retrofit sand filter as described above. The alternate components may be used instead of modules 52, 54 and pedestal 12 in the apparatuses and processes described above.

FIGS. 7 to 14 show an apparatus 100 having eight alternate vertical modules 102 forming two module arrays 106 resting on a multi component pedestal 104. The pedestal 104 may be made of a pair of injection molded supports 108, each of which has a first part and a second part which may be separated to accept a pipe between the parts. A permeate pipe segment 110 and two gas scouring pipe segments 112 may be held inside or on the supports 108. The pipe segments 110, 112 may be generally the same length as the pedestal 104, may be a multiple of the length of the pedestal, or may be of a length that provides manifolds 38, 40 in one piece spanning multiple pedestals 104. Segments 110, 112 may have male and female ends and be connected together by o-rings as shown or by gluing, welding or other means. A hole 114 in the gas pipe segments 112 below each module 102 allows gas to travel from the gas pipe segment 112 to an area surrounded by a skirt 116 at the bottom of the module 102. A generally vertical permeate pipe 118, is glued, or otherwise sealed, into a hole in the permeate pipe segment 110 and extends upwards. A vertical permeate pipe 118 can be sized such that the expected permeate flow will cause enough permeate velocity to draw bubbles on the permeate side down to permeate pipe 110. Alternately, an air removal system as described above may be used.

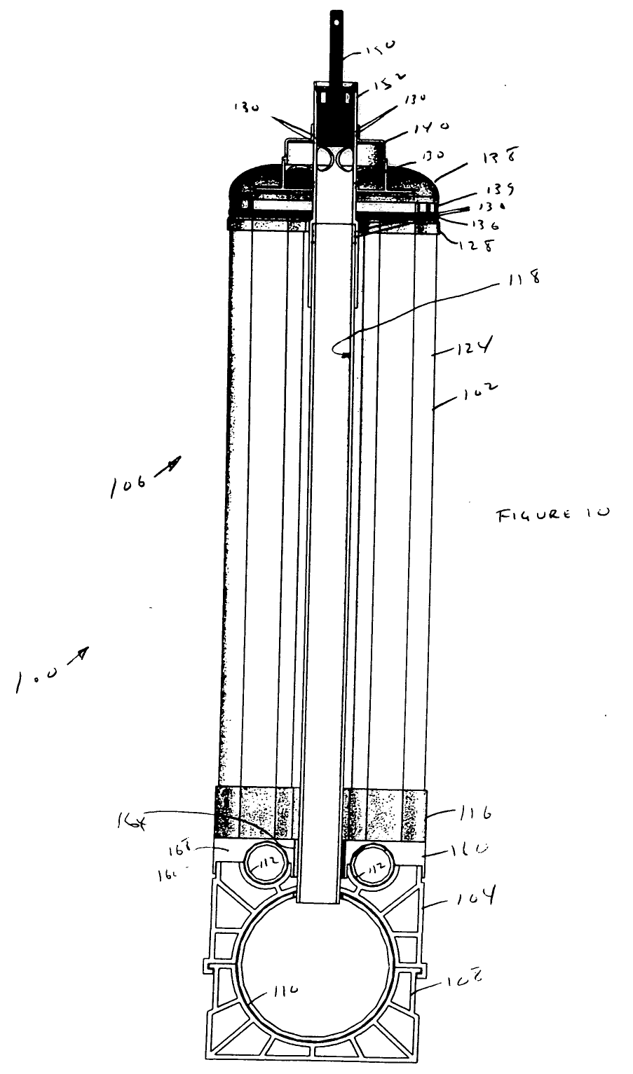

The modules 102 are constructed as shown particularly in FIG. 11. Starting from the bottom, skirt 116 holds a lower mass of structural urethane 120 and a lower mass of soft urethane 122. Lower urethane 120, 122 may have a number of small holes for gas to pass through them. For example, module 102 may be roughly 20 cm square and have 100 to 150 holes of 4 to 8 mm diameter. Skirt 116 may be sized to accommodate an air pocket of sufficient depth to create a flow of 0.4 to 0.05 scfm per hole. Lower ends of a bundle 126 of hollow fiber membranes may be sealed in lower structural urethane 120 and dispersed about the holes. A screen 124, for example a plastic mesh with about 5 mm openings, may be potted into skirt 116 at one end and an upper header surround 128 at the other end. As shown in FIG. 14, alternate upper header surrounds 128a,b,c, may have ribs 130a,b,c. Ribs 130 strengthen upper header surround 128 and also separate the membranes into sub-bundles near the top of module 102 to provide passages for bubbles or water to flow horizontally out of the module 102. Upper header surround 128 holds upper structural urethane 134 and upper soft urethane 132. The upper end of the membranes of bundle 126 are potted in upper urethane 134, 132 with their ends open to the upper face of upper structural urethane 134. Upper header surround 134 is sealed by o-rings 130 into array manifold 138 and held in place by tabs 139 and retainer rings 136. Retainer rings 136 may be elastomeric rings as shown, ring clamps or other structures with a variable diameter. Array manifold 138 has a manifold cap 140 sealed to the rest of array manifold 138 with o-rings 130.

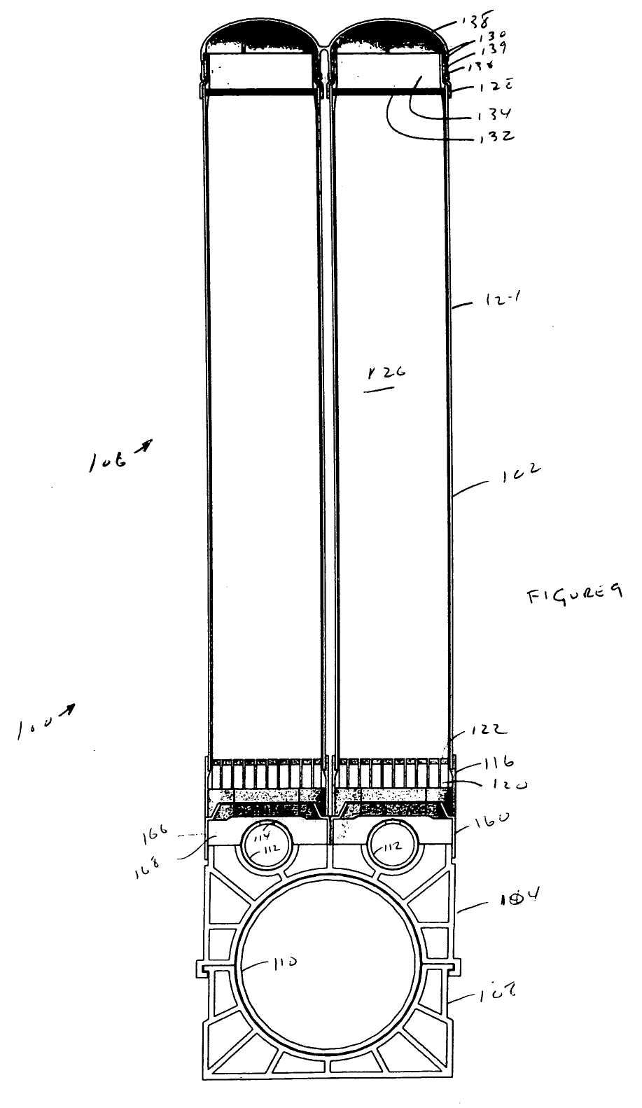

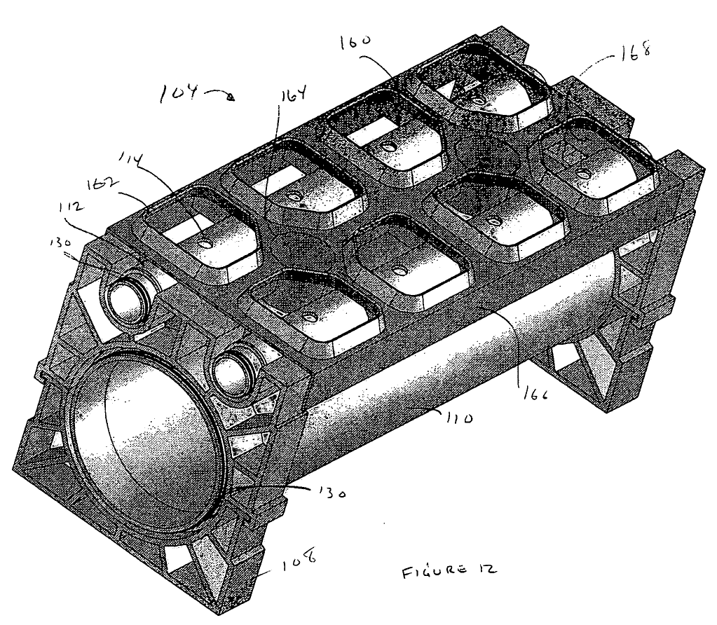

The tops of the four modules 102 of an array 106 are sealed to a common permeate collector comprised of the array manifold 138 and cap 140. The array manifold 138 and cap 140 each have a central opening and fit over the generally vertical permeate pipe 118, and are sealed to pipe 118 by o-rings 130, so the module array 106 can be installed or removed by moving it vertically. Permeate flows from the tops of the modules, to the space enclosed by array manifold 138 and cap 140 and through holes in the generally vertical permeate pipe 118. As shown in FIGS. 10 and 13, a valve plug 150 may be lowered to close the holes to the generally vertical permeate pipe 118 to isolate an array 106 or allow an array 106 to be removed while permeation continues with other arrays 106. Valve plug 150 may be movable directly in the main body of permeate pipe 118 acting as a valve body or as a separate valve body 152 attached to permeate pipe 118 which may serve as an upper part of permeate pipe 118.

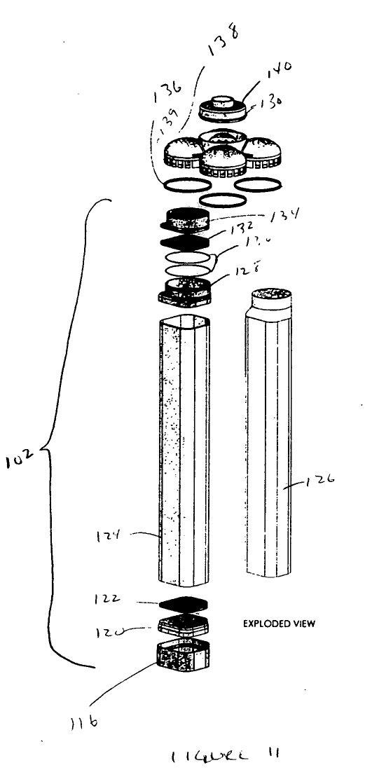

Referring particularly to FIG. 12, pedestal 104 comprises a tray 160 which rests on supports 108 directly or through gas pipes 112 or both. Tray 160 has module openings 162 which allow gas to flow from holes 114 to skirts 116 and also assist in holding modules 102 horizontally in place or guiding modules 102 into place as they are lowered onto tray 160. Tray 160 also has permeate pipe holes 164 with sides extending downwards from the main horizontal surface of tray 160. Side 166 and end 168 walls of tray 160 complete a plenum under the main horizontal surface of tray 160. This plenum may provide additional depth to allow a deeper air pocket to form under the modules 102 but also allows gas to escape under its edges if gas is accidentally supplied at an excessive flow rate. Pedestal 104 may optionally be of different lengths, for example to accommodate 1 or 3 arrays 106. Tray 160 may have tabs, not shown, to positively position lower ends of modules 102 or lower ends of modules 102 or an array 106 may be held to each other by a frame (not shown). Optionally, pedestal 104 may be used to hold air pipes 112 without also holding permeate pipe 110. In this case, a permeate pipe can be provided above modules 102 with vertical permeate pipe 118 extending upwards from manifold 138 rather than downwards.

We claim:

1. A filtration apparatus comprising:
a) a lower potting head having a plurality of air passages;
b) an upper potting head;
c) a plurality of hollow fiber membranes extending between the potting headers, the membranes each having a membrane wall and a lumen, the membrane walls sealed to the potting heads, the lumen in communication with an upper surface of the upper potting head;
d) a permeate collector sealed to the upper header and defining a permeate collection zone over the upper potting head and in communication with the lumens of the membranes;
e) a first permeate conduit in communication with and extending generally vertically downwards from the permeate collection zone and,
f) a releasable connection between the permeate collector and the first permeate conduit located near or above the upper potting head.

2. The apparatus of claim 1 having a gas distribution chamber below the lower potting head.

3. The apparatus of claim 1 having a second permeate conduit oriented generally horizontally below the lower potting head and connected to the first permeate conduit.

4. The apparatus of claim 1 wherein the bottom ends of the membranes are closed in the lower potting head.

5. The filtration apparatus of claim 1 further comprising a tank wherein the second permeate conduit rests on a pedestal on the floor of the tank.

6. The filtration apparatus of claim 1 wherein the lower potting head rests a pedestal.

7. The filtration apparatus of claim 1 wherein the pedestal further comprises a tray.

8. The filtration apparatus of claim 1 wherein the module is removable from the tank by moving the module vertically.

9. The filtration apparatus of claim 1 wherein the first permeate conduit extends downward into an opening in the second permeate conduit.

10. The filtration apparatus of claim 1 having a gas conduit parallel to the permeate conduit with an opening positioned so as to allow gas to flow from the gas conduit to the gas distribution chamber.

11. The filtration apparatus of claim 1 having a generally horizontally oriented retentate trough above the module.

12. The filtration apparatus of claim 1 wherein the permeate pipe is connected to an outlet near the bottom of the tank.

13. The filtration apparatus of claim 1 wherein the permeate conduit is comprised of a plurality of segments.

14. The filtration apparatus of claim 1 further comprising an air removal vacuum line connected to the permeate collection zone.

15. A filtration apparatus comprising, a pedestal further comprising a lower surface adapted to rest on a tank floor and an upper surface adapted to support a membrane assembly; a second permeate pipe held by the pedestal; and, a first permeate pipe extending upwards from the second permeate pipe.

16. The filtration apparatus of claim 15 further comprising a gas pipe held by the pedestal.

17. The filtration apparatus of claim 15 wherein the pedestal further comprises a tray.

18. The filtration apparatus of claim 17 wherein the tray has openings to permit gas to flow through the tray.

19. The filtration apparatus of claim 15 having an isolation valve at the top of the first permeate pipe.

20. The filtration apparatus of claim 15 having a module resting on the pedestal in communication with the first permeate pipe.

21. A membrane module having a first potting head, a plurality of gas passages through the first potting head, a bundle of hollow fiber membranes having first ends potted in and dispersed about the first potting head, a second potting head, a spacer between the potting heads, and second ends of the membranes potted into the second potting head in two or more sub bundles.

22. The module of claim 21 wherein the first ends of the membranes are sealed in the first potting head and the second ends of the membranes are open.
